(19) United States
(12) Patent Application Publication
(10) Pub. No.: US 2026/0310999 A1
(43) Pub. Date: Oct. 8, 2026

(54) METHODS AND SYSTEMS FOR DETERMINING CORRECTNESS OF MACHINE LEARNING MODEL OUTPUT

(71) Applicant: EIGEN TECHNOLOGIES LTD., London, Greater London (GB)

(72) Inventors: Momchil Preslavov Konstantinov, London (GB); Gregorio Benedetto Benincasa, London (GB)

(21) Appl. No.: 18/875,029

(22) PCT Filed: Jun. 12, 2023
(86) PCT No.: PCT/GB2023/051522

§ 371 Date: Dec. 13, 2024

Related U.S. Application Data
(60) Provisional application No. 63/352,196, filed on Jun. 14, 2022.

(51) Int. Cl. G06N 5/04

(52) U.S. Cl. CPC G06N 5/04

(57) ABSTRACT

The present disclosure provides methods and systems for generating a confidence label for a prediction produced by a predictive model. The method comprises: (a) generating training datasets for training a confidence model, the training datasets are generated using data collected from a cross validation process for evaluating the predictive model; (b) training the confidence model using the training datasets to learn a relationship between a score assigned by the predictive model to a prediction and a correctness measure of the prediction; and (d) feeding an input to the trained confidence model to output a confidence label. The input comprises a target precision or a target recall for a new prediction produced by the predictive model and a score assigned to the new prediction, and the confidence label indicates whether the new prediction is high confidence or low confidence.

### CROSS-REFERENCE TO RELATED APPLICATION

This application claims priority to U.S. Provisional Application No. 63/352,196 filed on Jun. 14, 2022, the content of which is incorporated herein in its entirety.

### BACKGROUND

Machine learning (ML) models have been used for document processing, information retrieval and data management platforms. For instance, in a question-answer task, a discriminative model may be used to determine if an answer exists in a piece of texts (i.e., extracting answer from document texts). In some cases, the predictive models may return a prediction, as well as a confidence score indicating the model's confidence in the prediction (e.g., the probability returned by logistic regression). A confidence score is a number between 0 and 1 that represents the likelihood that the output of a Machine Learning model is correct and will satisfy a user's request (the higher number the more likely the result of the model matching the user's request). However, models may not always produce the correct confidence score (e.g., a prediction of a class with confidence p is not correct 100*p percent of the time.). For example, a mis-calibrated model (due to insufficient training datasets and/or imbalanced training data) may result in confidence scores do not correspond to the probability of an answer being correct. There are methods for calibrating machine learning models (e.g., sigmoid method, isotonic regression, Platt scaling, etc.) which require finding a monotonic function mapping the confidence score to correctness such as by comparing confidence and accuracy on the test sample.

### SUMMARY

The present disclosure provides an alternative method for providing correctness of machine learning model outputs. In particular, methods and systems herein may be capable of providing user information about whether a prediction is of high confidence or low confidence by automatically determining the (optimal) threshold. Unlike the conventional method that relies on a monotonic mapping between confidence score and correctness for model calibration, the present disclosure provides a confidence model that automatically determines a threshold for determining whether a prediction is “high confidence” or “low confidence.” This beneficially avoids requiring manual tuning the threshold t for model calibration or for a user to find the optimal threshold. A user of the system herein may be permitted to accept/rely on the high confidence prediction and/or reject the low confidence prediction by simply providing a target precision or target recall.

Predictive models may return both a prediction and a confidence score indicating the model's confidence in the prediction (e.g., the probability returned by logistic regression). For instance, a probabilistic classifier is a function f: X→[0, 1] that maps each example x to a real number f(x). For a simple classifier, a threshold t may be selected for which the examples where f(x)>t are considered positive and the others are considered negative (implying that each pair of a probabilistic classifier and threshold t defines a binary classifier). For probabilistic classifiers, the measures are a function of the threshold t. For instance, TP(t) (True positives) which predicts “yes” and correct and FP(t) (False positives) which predicts “yes” and wrong are always monotonic descending functions.

The typical metrics used to measure model performance may include precision, accuracy, recall, or F score. Precision is the ability of a classifier not to label an instance positive that is actually negative. For each class, it is defined as the ratio of true positives to the sum of true and false positives. Recall is the ability of a classifier to find all positive instances. For each class, it is defined as the ratio of true positives to the sum of true positives and false negatives. The F1 score is a weighted harmonic mean of precision and recall such that the best score is 1.0 and the worst is 0.0. Accuracy measures proportion of correct predictions. The accuracy metric may be used when there is no interesting trade-off between a false positive and a false negative prediction. Depending on the type of classifier, the objective and gravity of decisions, different metrics may be used. For example, precision and accuracy are often used to measure the classification quality of binary classifiers.

However, models may be mis-calibrated due to insufficient training datasets and/or imbalanced training data. Miscalibration may result in confidence scores do not correspond to the probability of an answer being correct. For model calibration, the conventional way to calibrate a model is by changing the threshold that determines when the model predicts “Yes” or “No.” for instance, making the threshold stricter with class “Yes” and milder with class “No” may balance the proportion. Conventional model calibration requires learning a monotonic function which maps score to correctness (e.g., comparing confidence and accuracy on the test sample) and a user to find the threshold t based on the monotonic function. Such methods may require additional amount of data to learn the monotonic function and a user possess the expertise to calibrate the model.

In an aspect of the present disclosure, methods and systems are provided for generating a confidence label for a prediction produced by a predictive model. The method comprises: (a) generating training datasets for training a confidence model, the training datasets are generated using data collected from a cross validation process for evaluating the predictive model; (b) training the confidence model using the training datasets to learn a relationship between a score assigned by the predictive model to a prediction and a correctness measure of the prediction; and (d) taking an input by the trained confidence model to output a confidence label. The input comprises a target precision or a target recall for a new prediction produced by the predictive model and a score assigned to the new prediction. The confidence label indicates whether the new prediction is high confidence or low confidence.

In another aspect, a method is provided for generating a confidence label for a prediction. The method comprises: generating training datasets for training a confidence model; training the confidence model using the training datasets to learn a relationship between a score assigned to a prediction and a correctness measure of the prediction; and feeding an input to the trained confidence model to output a confidence label, where the input comprises a target precision or a target recall for a new prediction produced by a predictive model and a score assigned to the new prediction, and wherein the confidence label indicates that the new prediction is high confidence or low confidence.

In some embodiments, the training datasets are generated using data collected from a cross validation process for evaluating the predictive model. In some cases, the training datasets comprise paired datapoints. In some instances, each paired datapoint comprises a score assigned to a given prediction by the predictive model and a corresponding correctness measure. In some examples, the correctness measure is calculated based at least in part on the prediction produced by the predictive model during the cross validation process and a ground truth label.

In some embodiments, the relationship is based on a precision-recall analysis. In some cases, the relationship comprises one or more optimal points identified based at least in part on a precision-recall curve or a precision-recall-gain curve. In some embodiments, the confidence label is binary.

In some embodiments, the prediction produced by the predictive model comprises insight information extracted from a document in response to a user input. In some cases, the prediction comprises a chunk of texts relevant to the user input.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows an example of precision-recall (PR) curve and one or more optimal points.

FIG. 2 shows exemplary methods for computing correctness measure of a prediction result.

FIG. 3 shows an example process of generating training data for training a confidence model, in accordance with some embodiments of the present disclosure.

FIG. 4 shows an example process of training a confidence model, in accordance with some embodiments of the present disclosure.

FIG. 5 shows an example process of making inference using a trained confidence model.

FIG. 6 schematically shows a platform in which the method and system herein can be implemented.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Methods and systems of the present disclosure may comprise a predictive model trained to extract insight information (e.g., an answer to a user's question) or make any other predictions, with the capability to inform the user about how confident the model is in the prediction. In an aspect of the present disclosure, methods and systems are provided for generating a confidence label for a prediction produced by a predictive model. The method may comprise: (a) generating training datasets for training a confidence model, the training datasets are generated using data collected from a cross validation process for evaluating the predictive model; (b) training the confidence model using the training datasets to learn a relationship between a score assigned by the predictive model to a prediction and a correctness measure of the prediction; and (c) taking an input by the trained confidence model to output a confidence label. The input comprises a target precision or a target recall for a new prediction produced by the predictive model and a score assigned to that the new prediction, and the confidence label indicates whether the new prediction is high confidence or low confidence.

The methods and systems for providing correctness information for ML model outputs can be integrated into and/or applied to any platforms and applications. In some embodiments, the confidence model may be integrated into platforms for document processing, information and insight extraction and retrieval. The platform may augment a user's analysis and understanding of document content by incorporating a variety of machine learning (ML) techniques such as augmented machine learning (ML), and other techniques such as heuristics injection and knowledge collection. The platform may advantageously maximize and/or optimize the use of a user's knowledge while minimizing the computational budget by improving the interaction between Human and Machine, incorporating Human Computer Interaction techniques, machine learning techniques (e.g., supervised, unsupervised, semi-supervised, trial design), knowledge base construction techniques and the like.

The platform may be capable of efficiently and effectively retrieving and extracting information (e.g., answer or relevant sections) from a universe of documents (e.g., raw documents) along with the capability of informing a user of the correctness of the predicted information (e.g., answer or relevant sections). In some cases, the raw documents may comprise unstructured or semi-structured electronic document text. Unstructured text documents may contain “free text” in which the underlying information is mainly captured in the words themselves. The unstructured document texts may include, for example, open text, images, that have no predetermined organization or design. Semi-structured text may capture a significant portion of the information in the position, layout and format of the text but the information within has no structure. The platform herein may be capable of extracting information and retrieving insights from the raw documents by converting the raw document texts into structured data (e.g., document datasets, indexes) then retrieving insight needed or desired by a user with machine learning techniques.

Output of the predictive models of the platform may be provided to a user along with confidence labels. For example, the confidence model may automatically determine a threshold for determining whether a prediction made by the predictive models is “high confidence” or “low confidence.” In some embodiments, the predictive models may be dynamically constructed using user feedback data. For instance, the platform herein may train models to retrieve and extract information from a set of documents and a set of unseen documents by dynamically constructing models for retrieval and extraction, employ models benchmarks and model competition during training, improve the model training process and inform users when a model is properly trained, and/or use weak supervision for training large size models. Additionally, the models provided by the systems herein may adapt to a user's need by continuously learning from user's feedback or user's interaction with the system during the insight retrieval process. For instance, the user feedback data collected by the system may comprise clickthrough data (e.g., how quickly a user responds to a system suggested answer, how many passages/answers identified by the system as relevant are confirmed (e.g., clicked on) or ignored by the user, etc.), or comprise user input indicative of the relevant information to the user in a given document (e.g., system identified relevant information which the user may be interested in and the user may accept or reject the system identified relevant information or answer). The user feedback collected by the system can comprise various other data such as whether the user used a system suggested search term and/or question for inputting a query.

The platform herein may collect extracted knowledge or information for further improving insight querying. The extracted knowledge or information may be managed and maintained in knowledge bases (e.g., object model with classes, sub-classes, instances or other structures for storing structured and unstructured information). The systems and methods may employ various other suitable document processing techniques such as summarization, document diffing, coreference resolution and relation extraction, template filing, normalization of extracted fields and the like. The provided methods and systems can be implemented in various scenarios such as in cloud or an on-premises environment.

Various aspects of the systems and methods described herein may be applied to any applications where document analysis and intelligent information retrieval is involved. For instance, in industries such as banking, financial services, legal services, corporates, insurance, technology and various others, the amount of lengthy articles, regulatory documents, emails, and news articles being published are growing thus increasing the need to efficiently consume all the textual information a user needs to understand. The systems and methods provided herein may computationally extract and retrieve knowledge and information from complex and unstructured text to meet a user's intent with improved accuracy. Insights or knowledge may be extracted and retrieved for various purposes such as for analyzing legal contract or service agreement, regulatory reporting and compliance, and can be utilized in a wide range of industries as described above. It shall be understood that different aspects of the invention can be appreciated individually, collectively or in combination with each other.

As utilized herein, terms “component,” “system,” “interface,” “unit” and the like are intended to refer to a computer-related entity, hardware, software (e.g., in execution), algorithm, and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In some cases, a component can emulate an electronic component via a virtual machine, e.g., within a cloud computing system.

In some embodiments, methods and systems herein may provide various functions that can be implemented or accessed via web application program interfaces (APIs), a Software Development Kit (SDK), web-based integrated development environment (IDE) and the like. Various components of the system herein may be seamlessly integrated into a third-party platform or system via customized Software Development Kit (SDK) or APIs. For instance, intelligent information extraction and retrieval as well as document processing modules may be provided via open-ended integration with a full suite of APIs and plugins thereby allowing for convenient and seamless system integrations into any third-party systems.

In some embodiments, the platform may be a no-code user-friendly platform that requires only a small amount of training datasets to deliver highly accurate results across a wide range of document types and data formats. The platform herein may train models to be able to extract relevant information relating to a user input from documents. The platform herein may train a confidence model to automatically classify the predictions made by the data extraction models as high confidence or low confidence. The data extraction models may be trained on a relatively small number of documents, and still provide accurate outcomes when used to analyze documents. For example, the platform may provide customized models using limited training datasets (e.g., 2-50 examples) to fine tune the models to extract and retrieve information from any document, for any data, any user and any use case. This greatly reduces the time and effort required by a user before the system can commence useful data extraction.

The confidence model herein may be utilized in various applications for classifying predictions as high confidence or low confidence. In the example of information extraction/retrieval, a user-friendly user interface (UI) may be provided which allows user to specify the information needed in natural language-based question, using search terms, positive or negative keywords of any combination of the above with improved flexibility. The UI may display information about whether the prediction i.e., extracted information, is high confidence or low confidence. The UI may also allow the user to interact with the extracted information and collect user feedback data related to the relevancy of the extracted information which user feedback data may be utilized by the system to further improve the information retrieval models in an automated fashion. For example, the platform herein may provide improved flexibility for a user to provide input via a user interface (UI) to specify the desired or interested information or to retrieve information from one or more documents. The UI may also display confidence information associated with the retrieved or extracted information indicating how confident the data extraction model is in the prediction. The platform herein may allow a user to provide an insight query input in various formats or types. For instance, a user may be allowed to provide search terms, an intelligent question, positive or negative keywords or any combination of the above in order to specify the desired information. The system may process the user input in the one or more types or input channels in respective processes and identify the relevant information by aggregating a plurality of similarity and relevancy scores as well as the real-time user feedback data in a unique process. Although the confidence model is described in the context of information extraction and information retrieval, it should be noted that the method can be applied to classify any predictions in various applications without limitation.

The confidence model herein may be used in combination with any predictions. In some cases, an output provided by a system may comprise a prediction along with confidence information associated with the prediction. For example, the output provided by an information extraction or retrieval system may comprise the relevant information and/or answer in response to a user input querying the information. The output provided by the system may further comprise confidence information associated with the retrieved information indicating how confident the data extraction model is in the prediction. For instance, the retrieved information may be displayed along with a confidence label e.g., “high confidence” or “low confidence.” Alternatively, the confidence label may not be displayed on the UI whereas only the high-confident predictions (e.g., answer, relevant information) may be provided to the user on the UI. The term “relevant information” as utilized herein may generally refer to target of information to satisfy the user's information needs or texts in one or more sections from the original document (e.g., highlight salient passages) relevant to the user's query such that the user can make informed decisions based on such information, For instance, the system output may comprise relevant pieces of information which the user may rely on to determine/satisfy some criterion. The term “answer” as utilized herein may refer to a word, short phrase or a span of texts that directly answer a question specified in the query input. In some cases, an “answer” may not be provided if there is no question specified in the query input and/or when the question cannot be answered by extractive texts from the original document.

In some cases, the various different models for extracting the answer and relevant passage/section may generally refer to data extraction models but with different input features or network architecture. The predictions made by the data extraction models may be provided to a user along with a confidence label generated by the confidence model herein. In some cases, the confidence label may be binary classification indicating whether the prediction produced by the data extraction models is low confidence (high confidence) or not.

Methods and systems of the present disclosure may provide a predictive model trained to extract an answer to a user's question, with the capability to inform the user about how confident the model is in the prediction. The confidence information (e.g., confidence labels) associated with a prediction may be provided by a confidence model.

In some embodiments, the provided system and method may provide a confidence model that is trained to learn a relationship between a score (which a predictive model assigns to its predictions) and a correctness measure (measures how correct these predictions are). Once the confidence model learns the relationship i.e., is trained, the trained confidence model may be deployed for making inference. The confidence model may accept a target precision (tp) (or target recall) and then divide any given new predictions based on their score into two groups such as low confidence and non-low confidence. In some cases, the input to the trained confidence model may comprise a target precision (or target recall), and the output of the trained confidence model may be binary or confidence labels e.g., low confidence label and non-low confidence label.

The confidence model may be trained to assign the non-low confidence and low confidence label to the predictions such that—for the predictions determined to be in the non-low confidence group (or predictions assigned to be non-low confidence), on average tp*100% are correct among the non-low confidence predictions (based on the correctness measure); for the predictions determined to be in the low confidence group (or predictions assigned to be low confidence), on average, assigning low confidence to fewer predictions will result in fewer than tp*100% of the non-low confidence predictions being correct. Such confidence model may beneficially avoid the conventional model calibration which usually requires finding a monotonic mapping between the confidence score and the correctness or manual tuning the threshold t (e.g., threshold determines when predictions are considered positive/negative for a binary classifier) to achieve a desired correctness.

As described above, predictive models may assign a score to a prediction as part of the model output. The score indicates the model's confidence in the prediction (e.g., the probability returned by logistic regression). In some cases, the score may be a number between 0 and 1 that represents the likelihood that the output of a predictive model is correct and will satisfy a user's request (the higher number the more likely the result of the model matching the user's request). However, the scores may not correspond to the probability of an answer being correct due to insufficient training datasets, imbalanced training data or mis-calibration. The present disclosure provides a confidence model configured to automatically determine whether a prediction made by a predictive model is of high (low) confidence or not based on the score assigned by the predictive model and a target precision (or target recall).

In some embodiments, the confidence model may be trained based on data (e.g., predictions) collected from cross-validation associated with a predictive model. For example, during a k-fold cross-validation (k=2, 3, 4, 5, 6, etc.) for evaluating a predictive model, the training data set for the predictive model may be split into k smaller sets. The predictive model is trained using k−1 of the folds as training data; the resulting predictive model is validated on the remaining part of the data. For instance, the remaining part of the data may be used as a test set to compute the performance metrics (e.g., accuracy, recall, precision, F score, etc.) for evaluating the predictive model.

Due to the scarcity of pairs of score and correctness measures, reusing data from cross-validation beneficially provides sufficient training datasets for training the confidence model. This advantageously avoids the need for additional training data for the confidence model. For example, in a 3-fold cross-validation, a predictive model is trained on folds 1 and 2, predicts on fold 3 and assigns scores to its predictions (based on fold 3); the model is trained on folds 1 and 3, predicts on fold 2 and assigns scores to its predictions (based on fold 2); the model trained on folds 2 and 3, predicts on fold 1 and assigns scores to its predictions (based on fold 1). The training dataset for training the confidence model may comprise paired datapoints each pair includes a model-assigned score and a correctness measure. The paired datapoints may be obtained by combining (e.g., concatenating) the predictions from the different folds to obtain a dataset of predictions, each is associated with a model-assigned score. For each prediction, the ground truth (e.g., ground truth from the training dataset fold 1, fold 2, fold 3) is also collected which is used along with the prediction to compute the corresponding correctness measures. Details about calculating the correctness measure is described later herein.

The confidence model may be trained on paired datapoints (xᵢ, yᵢ), where i ranges over the predictions, xᵢ represents the model-assigned score and yᵢ represents the correctness measure computed for each prediction. The paired datapoints (xᵢ, yᵢ) may be obtained from the test folds of the cross validation as described above.

Once the confidence model is trained, the trained model may be deployed and executed to assign a confidence label to a new prediction made or produced by the predictive model. The confidence label may be binary. For example, the confidence label may be either a low confidence label or a non-low confidence label. In another example, the confidence label may be either a high confidence label or a low confidence label. In some cases, the confidence model may take as input (tp, x), where tp represents the target precision and x is the model-assigned score of the prediction. The output of the of the confidence model may comprise confidence labels such as high confidence and low confidence. For example, the confidence model may return a binary result such as boolean result: True/False, indicating whether the prediction is to be considered high confidence for the given target precision. It should be noted that although target precision is taken as the input for determining an optimal recall, the input may, instead of the target precision, comprise a target recall where the optimal threshold may correspond to the optimal precision.

In some embodiments, the confidence model may be a binary classifier trained using any suitable machine learning algorithm. The machine learning algorithm may comprise one or more of the following: a support vector machine (SVM), a naïve Bayes classification, a linear regression model, a quantile regression model, a logistic regression model, a random forest, decision tree, k-Nearest Neighbors, and the like.

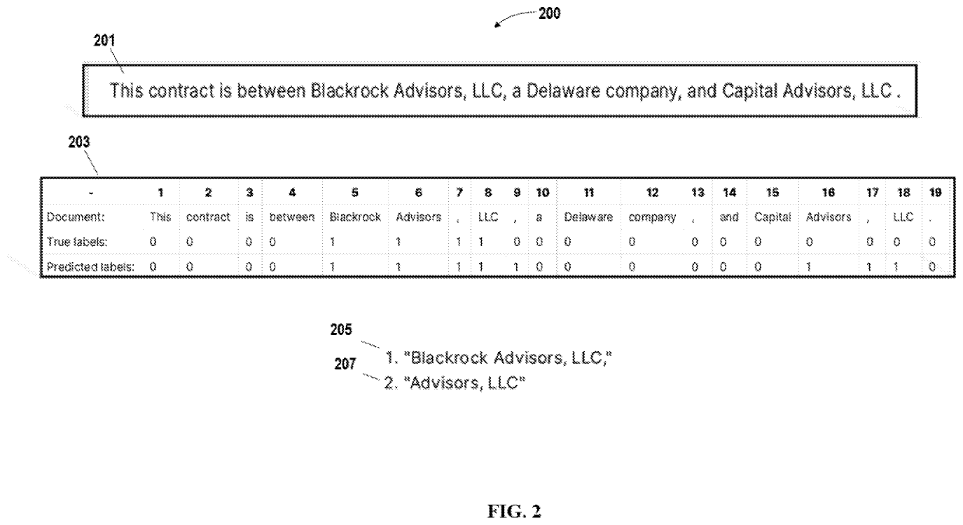

A confidence model may be fitted to the training datasets. As described above, the training datasets may comprise paired datapoints and each pair includes a model-assigned score (associated with a prediction) and a correctness measure (associated with the prediction). In some embodiments, the confidence model may be developed based on precision-recall analysis. For instance, during the training process, the confidence model learns one or more optimal points at which to threshold the score such that no other threshold can achieve both a higher precision (i.e. greater proportion of correct predictions with score above the threshold) and a higher recall (i.e. having more correct predictions with score above the threshold). Note that the values of precision and recall metrics may be calculated based on the method selected for calculating the correctness measure and the score for thresholding can be any of the ones above. Selection of the method for correctness measure calculation is described with respect to FIG. 2.

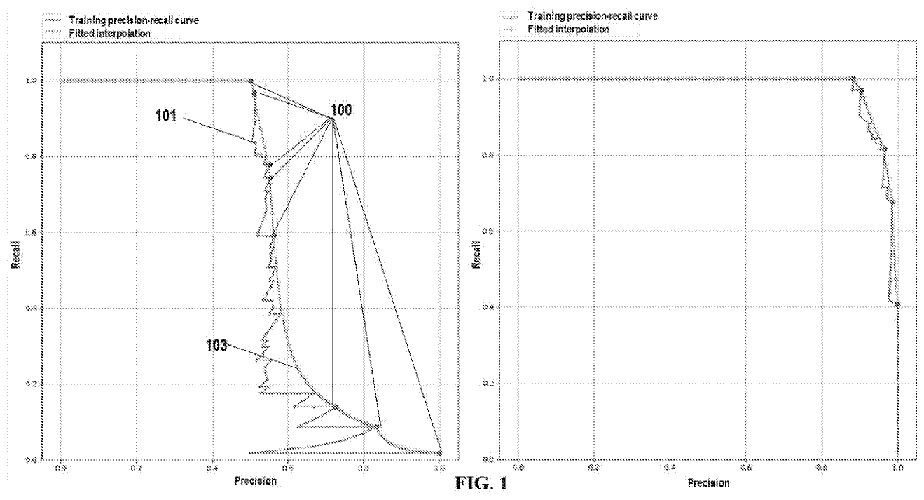

FIG. 1 shows an example of precision-recall (PR) curve 101 and one or more optimal points 100. As shown in the example, the precision-recall curves 101 provide a graphical representation of a classifier's performance across a variety of thresholds. Assuming the input pairs of model-assigned scores and correctness measure values is sorted by decreasing score:

$$D = \{ ( {x}_{i} , {y}_{i} ) \text{:} 1 \leq i \leq n , i < j ⇒ {x}_{i} \geq {x}_{j} \} ,$$

the precision-recall (PR) curve 101 is

$$PR = \{ ( {x}_{i} , {r}_{i} , {p}_{i} ) \} , where {p}_{i} = \frac{1}{i} {\sum }_{j = 1}^{i} {y}_{j} and {r}_{i} = \frac{{\sum }_{j = 1}^{i} {y}_{j}}{{\sum }_{j = 1}^{n} {y}_{j}}$$

where r represents recall, p represents precision. To find the optimal points, a Precision-Recall-Gain (PRG) curve may also be generated. The PRG curve plots Precision Gain on the y-axis against Recall Gain on the x-axis in the unit square (i.e., negative gains are ignored). The PRG curve may be obtained by the following: PRG={xᵢ, rgᵢ, pgᵢ)}, where

$${pg}_{i} = \frac{{p}_{i} - {p}_{n}}{( 1 - {p}_{n} ) {p}_{i}}$$

$$and$$

$${rg}_{i} = \frac{{r}_{i -} {p}_{n}}{( 1 - {p}_{n} ) {r}_{i}} .$$

Note that

$${p}_{n} = \frac{1}{n} {\sum }_{j = 1}^{n} {y}_{i}$$

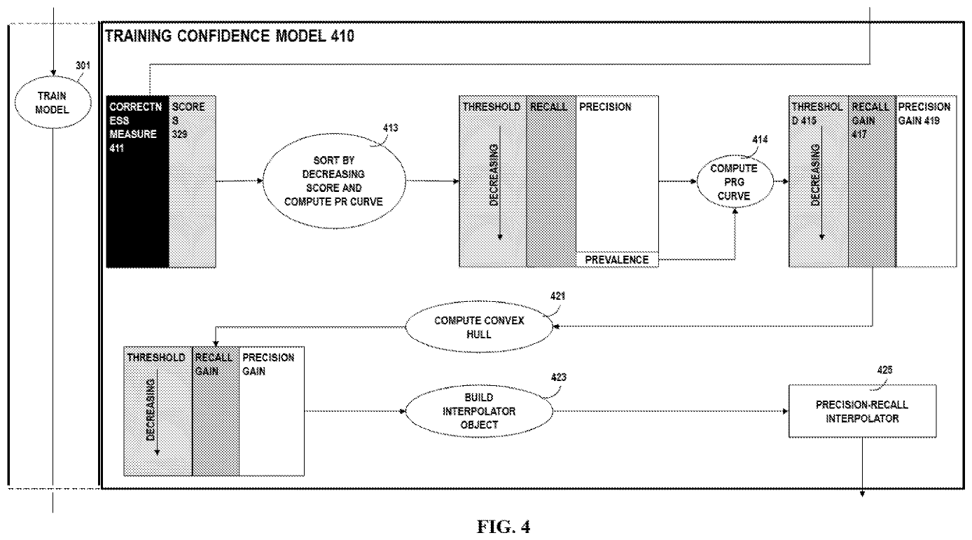

is the proportion of positives in the data set, also known as the prevalence (see FIG. 4).

The optimal points 100 may refer to points on the PR-curve whose corresponding points on the PRG-curve lie on its convex hull. This condition implies that if (xᵢ, rᵢ, pᵢ) is an optimal point, then there is no other point on the PR-curve 101 which has both recall higher than rᵢ and precision higher than pᵢ. In the illustrated example, the best theoretical PR-curve 103 may be obtained by interpolating the optimal points 100.

As described above, training the confidence model may comprise finding the optimal thresholds in the data obtained from cross-validation. The optimal thresholds correspond to the optimal points which can be identified from the PR curve and PRG curve as described above. For each optimal threshold tᵢ (from a plurality of optimal thresholds t₀, t₁ . . . tₖ), a corresponding precision value pᵢ is obtained which is equal to the average correctness measure of predictions with score higher than tᵢ.

Once the confidence model is trained, it may be deployed to make predictions such as assigning confidence labels based on the input including a target precision tp. In some cases, the target precision tp may be specified by a user or specified using any other suitable methods. The tp may be, for example, a value falling within [0, 1]. In some cases, the target precision happens to be equal to precision value pᵢ, which is one of the precisions achieved at the optimal thresholds that the confidence model learned when it was trained. In such case, the confidence model may assign the low confidence label to all predictions whose score is below the corresponding optimal threshold tᵢ and the non-low confidence label to all predictions whose score is above tᵢ.

In some cases, the target precision may fall between the precisions of two optimal threshold, i.e. pᵢ<tp<pᵢ₊₁, the confidence model may assign the low confidence label to all predictions whose score is below tᵢ and the non-low confidence label to all predictions whose score is above tᵢ₊₁. In some embodiments, for the confidence model predictions whose score falls between two thresholds, the confidence model may decide which confidence label to assign by flipping a coin. The coin may or may not be 50/50 coin. In some cases, the coin may have a coin bias computed by a formula. The formula may ensure that, on average, the target precision tp will be achieved and as many predictions as possible will be assigned the non-low confidence label.

The confidence model as described above can be advantageously useful for assigning confidence when the predictive model is a complex model or not a simple classifier (i.e., binary classier). For example, when the model is Conditional Random Fields (CRF) as data extraction models utilized to analyze documents, the confidence model and method as described above may be employed to provide confidence tag/label of an extracted answer predicted by the CRF sequence model. It should be noted that although the confidence model and confidence assignment method are described in the context of document processing and information extraction, the method can be utilized in any other applications without limiting.

For instance, the confidence model may be utilized to determine the confidence classification for an answer and/or section extracted/predicted by a CRF model. The answer may be extracted from document according to a user inputted query or question. For example, the CRF model is a discriminative model trained to compute the probability of a given label sequence L for a given token sequence S (i.e. the probability that L is the correct label sequence for S), such that feature j of token st depends (at most) on its position i in the sequence S, any token in the sequence, its own label lt, the label of the previous token li−1. The summation of feature functions over all positions in the sequence and all features may be referred to as a “score” assigned to label sequence L given token sequence S, and the CRF may score each label sequence L for the given token sequence S (the higher the score, the higher the probability). The confidence model herein may take a target precision (or target recall) as input and determine whether the output of the CRF is of high confidence or not by thresholding the score.

The methods and systems herein may provide multiple choices for calculating a score and multiple choices for calculating the correctness measure. For instance, the score (full_predicted_crf_score) may be defined as the probability that the CRF assigns to the predicted label sequence for the entire document. In such case, if a document has more than one predicted answer, each of the predicted answers may be assigned the same score. In other cases, the score (isolated_predicted_crf_score) may be defined as the probability that the CRF assigns to the label sequence which represents a prediction as if it were the only prediction in that document. This score may differ from the full_predicted_crf_score only for documents in which the CRF has predicted more than one answer.

The system and method herein may also provide different methods for calculating a correctness measure for a predicted answer. FIG. 2 shows an example 200 of computing correctness measure for a prediction result using different methods. In the example of Information Extraction, the predictive model may operate indifferently on a word or section token level. For example, the predictive model may be a point extraction model for predicting an answer or a section extraction model for predicting relevant sections. The predicted answer or predicted section may comprise contiguous block of words or sections that the model has identified as relevant. A single document may contain multiple predicted answers and the methods herein may measure correctness for the multiple predicted answers/sections individually. As described above, although the confidence classification method is described with respect to natural language processing tasks, it can be utilized in any prediction tasks without limitation.

As illustrated in FIG. 2, a document 201 may be processed by a predictive model to extract answers. In the illustrated example, the model may be trained to extract “first party” and the model extracted two predicted answers 205, 207. The prediction of the model may comprise predicted labels for reach word 203. The correctness measure for the two predicted answers 205, 207 may be calculated. The system herein may provide different methods to calculate the correctness measure.

A first correctness measuring method may measure the correctness of a predicted answer based on whether there is a labelled answer at the same position in the document. The correctness metric may be computed based on a positional overlap between the predicted answer and labelled answer. In the illustrated example, the correctness measure for the first predicted answer 205 is 0.89 (8/9 overlap) and the correctness measure for the second predicted answer 207 is 0 (0/4 overlap).

A second correctness measuring method may measure the correctness of a predicted answer based on whether a similar text appears among the true answers (true labels). In the illustrated example, the correctness measure (text_based_precision) of the first predicted answer 205 is 1 and the correctness measure (text_based_precision) of the second predicted answer is 0.8 (because it matches the text of the correct answer). In some cases, the text_based_precision calculates a numerical score which is the maximal similarity between the predicted texts (answer) and the true texts (answer). For instance, numerical score may be computed based on the maximal number of consecutive “significant” words that the texts of the predicted answer and texts of the true answer have in common: N_{common}, compared to the number of “significant” words in the predicted answer: N_{predicted}, and true answer Nₜᵣᵤₑ. The term “significant” may generally refer to the words left after operations such as stopwords removal, stripping non alphanumeric characters, stripping multiple whitespaces, stripping punctuation, stripping tags (e.g., <b> . . . </b>), and the like. In some cases, the similarity may be calculated based on the harmonic mean of the two ratios N_{common}/Nₜᵣᵤₑ and N_{common}/N_{predicted}.

It should be noted that the above method for computing the similarity score is for illustration purpose only and various other methods or operations may be performed for computing the similarity score and/or comparing a predicted result and true result. For example, when scoring an information extraction question which contains dates, the true answer (true dates) and the predicted answer (predicted dates) may be first converted to a standard form and then compared to determine a match. This is because very different dates can be very similar in terms of text (e.g., “Dec. 6, 2020” vs “Dec. 6, 1920”).

Each answer may be assigned the probability score corresponding with the given sequence prediction. The score for the predicted answer may be produced by the CRF model. As described above, there can be different methods for extracting the score. The probability score assigned to an answer can be represented in various formats. For example, a score may be defined as the probability that the CRF assigns to the predicted label sequence for the entire document (e.g., both of the predicted answers 205, 207 are assigned the same probability score probability ([0, 0, 0, 0, 1, 1, 1, 1, 1, 0, 0, 0, 0, 0, 0, 1, 1, 1, 0])). In another example, the score may be defined as the probability (isolated_predicted_crf_score) that the CRF assigns to the label sequence which represents a prediction as if it were the only prediction in that document (e.g., predicted answer 205 is assigned the score: probability ([0, 0, 0, 0, 1, 1, 1, 1, 1, 0, 0, 0, 0, 0, 0, 0, 0, 0, 0]), predicted answer 207 is assigned score: probability ([0, 0, 0, 0, 0, 0, 0, 0, 0, 0, 0, 0, 0, 0, 0, 1, 1, 1, 0]).

The different methods for extracting the probability score and the methods for calculating the correctness measures may be selected and combined. In some cases, the system may generate multiple different datasets by calculating the probability scores and correctness measures using different combinations of the methods, then train multiple instances of confidence models using the multiple different datasets. The system may then select the combination of the methods corresponding to the confidence model having a relatively good performance (e.g., confidence model capable of labeling the pipeline's superfluous predictions as low confidence). For example, a default method combination may use a score generated using a first scoring method (e.g., full_predicted_crf_score) as a model-assigned score and a correctness metric generated using a first correctness measurement method (e.g., text_based_precision) as the correctness measure. If the predictive model (CRF) has a low accuracy (e.g., predicts several answers per document while only one is correct), then a different combination may be adopted. For example, the new combination may use a score generated using a second scoring method (e.g., isolated_predicted_crf_score) as a model-assigned score and a correctness metric generated using a second correctness measurement method (e.g., positional overlap-based metric) as correctness measure.

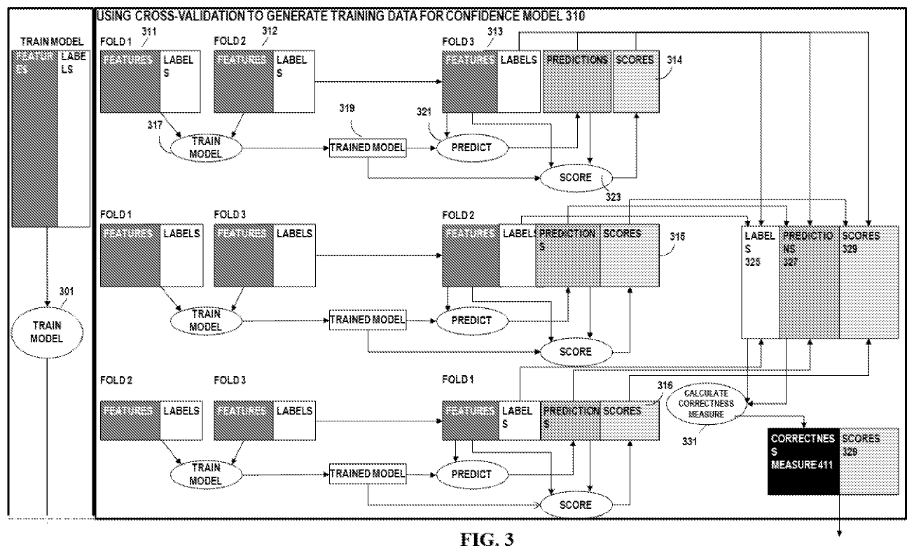

FIGS. 3-5 show exemplary process flow for obtaining training datasets 310, training the confidence model 410, and making inference 510, in accordance with some embodiments of the present disclosure. As illustrated in FIG. 3, the training data for training the confidence model 301 may be obtained from a cross-validation process 310. As described above, the confidence model may be trained 301 based on data (e.g., predictions) collected from cross-validation. For example, during a k-fold cross-validation (k=2, 3, 4, 5, 6, etc.) for model evaluation, the training set is split into k smaller sets 311, 312, 313. The model is trained using k−1 of the folds 311, 312 as training data; the resulting model is validated on the remaining part of the data 313. For instance, the remaining part of the data may be used as a test set to compute the performance metrics (e.g., accuracy, recall, precision, F score, etc.) for evaluating the predictive model 319.

FIG. 3 shows an example of a 3-fold cross-validation, a predictive model 317 (e.g., data extraction model) is trained on folds 1 311 and fold 2 312. The trained model 319 predicts or make inferences on fold 3 313 and assigns scores 314 to its predictions. The model is trained on folds 1 and 3, predicts on fold 2 and assigns scores 315 to its predictions. The model is also trained on folds 2 and 3, predicts on fold 1 and assigns scores 316 to its predictions. The training dataset for training the confidence model may be obtained by combining (e.g., concatenating) the predictions 314, 315, 316 from the different folds to obtain a dataset of predictions 327, each is associated with a model-assigned score 329. For each prediction, the ground truth 325 is also collected which is used along with the prediction 327 to compute the corresponding correctness measures 331. The methods for calculating the correctness measures can be the same as those as described above. The correctness measure 411 and the model-assigned score 329 may form pairs of data for training the confidence model.

Continuing with the process of training the confidence model 410 as illustrated in FIG. 4, the correctness measure 411 and the model-assigned score 329 may form paired datapoints (xᵢ, yᵢ), where i ranges over the predictions, xᵢ represents the model-assigned score 329 and yᵢ represents the correctness measure 411 computed for each prediction. The pairs of model-assigned scores and correctness measure values may be sorted by decreasing score: D={(x, y):1≤i≤n, i<j⇒xᵢ≥xⱼ} and the PR curve may be computed PR={(xᵢ, rᵢ, pᵢ)}, where

$${p}_{i} = \frac{1}{i} {\sum }_{j = 1}^{i} {y}_{j}$$

$$and$$

$${r}_{i} = \frac{{\sum }_{j = 1}^{i} {y}_{j}}{{\sum }_{j = 1}^{n} {y}_{j}} 41 \; 3 .$$

The Precision-Recall-Gain (PRG) curve may also be computed 414 to obtain the precision gain (pg) 419 and recall gain (rg) 417 for a variety of thresholds 415 as described above. Next, the convex hull of the PRG-curve may be computed 421 and interpolator object may be built 423 by identifying a plurality of optimal points (points on the PR-curve whose corresponding points on the PRG-curve lie on its convex hull) and a best theoretical PR curve is generated by interpolating the optimal points 425.

During the training process, the confidence model identifies the optimal points at which to threshold the score such that no other threshold can achieve both a higher precision (i.e. greater proportion of correct predictions with score above the threshold) and a higher recall (i.e. having more correct predictions with score above the threshold). The optimal thresholds correspond to the optimal points which can be identified from the PR curve and PRG curve as described above. For each optimal threshold tᵢ (from a plurality of optimal thresholds t₀, t₁ . . . tₖ), a corresponding precision value pᵢ is obtained which is equal to the average correctness measure of predictions with score higher than tᵢ.

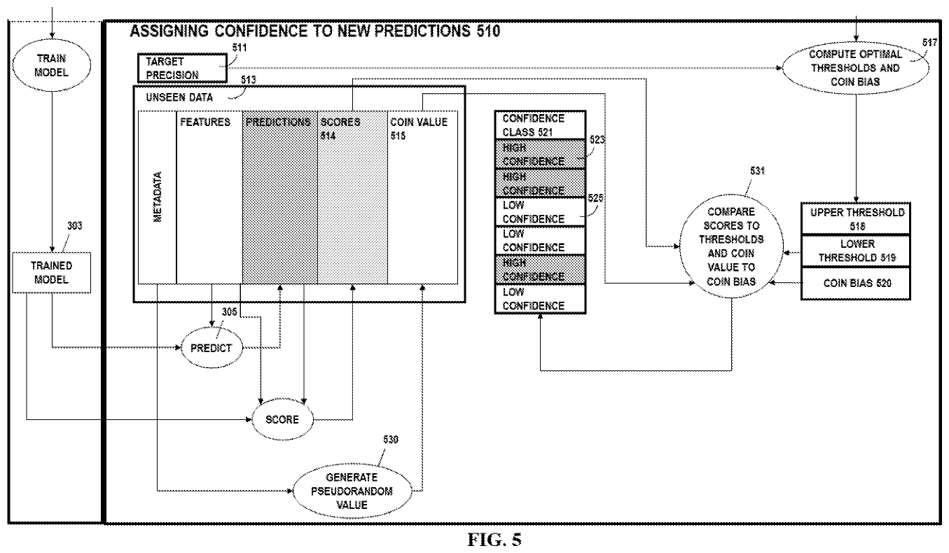

During an inference process or inference stage (e.g., after model is deployed) 510 as illustrated in FIG. 5, the trained confidence model 303 may make prediction 305 by assigning confidence labels 523, 525 to unseen data 513 based at least in part on a target precision tp 511. In some cases, the target precision tp 511 may be specified by a user using any suitable method. The tp 511 may be, for example, a value falling within [0, 1]. In the case, when the target precision happens to be equal to the precision value pᵢ, which is one of the precisions achieved at the optimal thresholds that the confidence model learned when it was trained. In such case, the confidence model may assign the low confidence label 525 to all predictions whose score is below the corresponding optimal threshold tᵢ and the non-low confidence label 523 to all predictions whose score is above tᵢ.

In some cases, the target precision may fall between the precisions of two optimal threshold, i.e. pᵢ<tp<pᵢ₊₁, the confidence model may assign the low confidence label to all predictions whose score is below tᵢ and the non-low confidence label to all predictions whose score is above tᵢ₊₁. For predictions whose score falls between two thresholds 518, 519, the confidence model may decide which confidence label to assign by flipping a coin 530 (e.g., generate pseudorandom value between [0, 1]) to generate a coin value 515. The coin may or may not be 50/50 coin. In some cases, the coin may have a coin bias 520 such as computed by a formula 517. The formula may ensure that, on average, the target precision tp will be achieved and as many predictions as possible will be assigned the non-low confidence label.

The confidence model may predict the confidence class 521 such as high confidence label 523 or low confidence label 525 by comparing 531 the coin value 515 to the coin bias 520 and comparing 531 the scores 514 to the two thresholds 518, 519. The scores are assigned by any suitable predictive model (e.g., data extraction model) to its predictions. For instance, the confidence model may assign the low confidence label 525 to all predictions whose score is below the lower threshold tᵢ 519 and the non-low confidence label (e.g., high confidence label 523) to all predictions whose score is above the upper threshold tᵢ₊₁ 518.

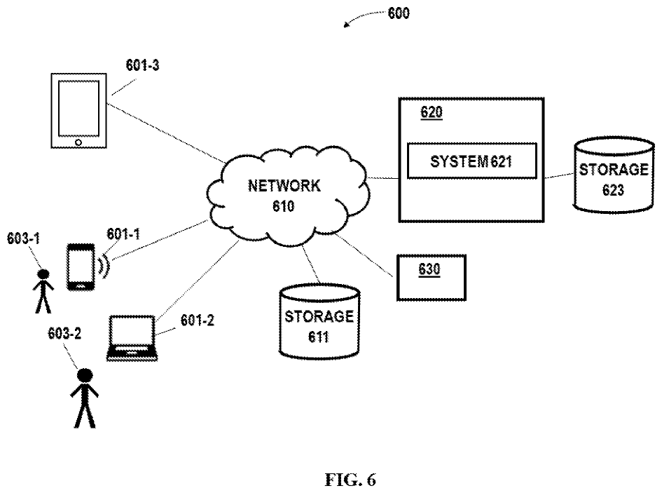

The confidence model can be used to assign a binary confidence label to any predictions as an output of a predictive model. For example, in the realm of Natural Language Processing (NLP) the predictive model may be a deep learning model trained for extracting information, such as an answer from a document in response to a user query, a question or extracting relevant sections based on a user input search terms. The confidence model may be integrated into an insight query or information search platform. FIG. 6 schematically shows a platform 600 in which the method and system herein can be implemented. A platform 600 may include one or more user devices 601-1, 601-2, 601-3, a server 620, a system 621, one or more third-party systems 630, and a storage unit 611, 623. Each of the components 601-1, 601-2, 601-3, 611, 620, 621, 623, 630 may be operatively connected to one another via a network 610 or any type of communication link that allows transmission of data from one component to another.

The system 621 may be configured to permit users to perform insight query or information search through one or more documents. The system 621 may include a plurality of functional components such as retriever engine, reader engine, recommending system, confidence model, user interface module, model creation and management system, and/or various others described elsewhere herein.

In some cases, the system 621 may be configured to train and develop a plurality of predictive models (e.g., RNN, CNN, GAN, classifiers, etc.) consistent with the methods and functions described herein. The system 621 may train and develop a confidence model as described above. The system 621 may be configured to perform one or more operations and provide one or more features consistent with those described elsewhere herein. For example, the system 621 may provide pre-trained models and may fine tune the pre-trained models with custom or private datasets to provide customized models. For instance, the system may initialize encoder-decoder model with pre-trained encoder and/or decoder checkpoints (e.g., Bidirectional Encoder Representations from Transformers (BERT), Generative Pre-trained Transformer 2 (GPT-2)) to skip the costly pre-training. In some cases, the system 621 may further comprise binary classification models such as the aforementioned confidence model to classify the retrieval results generated by the system as high confidence or low confidence. In some embodiments, the generative models and/or the classification models may be transformer-based models which may be fine-tuned using custom datasets. The datasets may be generated manually such as by manual labelling, collected by the system (e.g., user clickthrough data) or generated automatically or semi-automatically by a labeling system. In some cases, custom datasets may be utilized to fine-tune a preliminary model (e.g., pretrained model). In some cases, insights extracted by the system or newly collected user feedback data may be used to retrain or update a predictive model.

In some embodiments, the system may be implemented in a cloud-based platform. For example, the front-end of the system may be implemented as a web application using the framework (e.g., Django Python) hosted on an Elastic Cloud Compute (EC2) instance on Amazon Web Services (AWS). The backend of the system may be implemented as serverless compute service such as hosted on AWS Lambda as a serverless compute service running a web framework for developing RESTful APIs (e.g., FastAPI). This may beneficially allow for a large scale implementation of the system. For instance, the backend system (e.g., AWS Lambda) may partition a separate (e.g., 10 GB RAM) compute service for each independent document submission, allowing for a large number of concurrent submissions.

The system 621 may be implemented anywhere within the platform, and/or outside of the platform 600. In some embodiments, system 621 may be implemented on server 620. In other embodiments, a portion of the system 621 may be implemented on the user device. Additionally, a portion of system 621 may be implemented on the third-party system 630. Alternatively or in addition to, a portion of the system 621 may be implemented in one or more storage units (e.g., knowledge base, data lakes, databases) 611, 623. The system 621 may be implemented using software, hardware, or a combination of software and hardware in one or more of the above-mentioned components within the platform.

In some embodiments, a user 603-1, 603-2 may be associated with one or more user devices 601-1, 601-2, 601-3. User device 601-1, 601-2, 601-3 may be a computing device configured to perform one or more operations consistent with the disclosed embodiments. Examples of user devices may include, but are not limited to, laptop or notebook computers, desktop computers, mobile devices, smartphones/cell phones, wearable device (e.g., smartwatches), tablets, personal digital assistants (PDAs), media content players, television sets, video gaming station/system, virtual reality systems, augmented reality systems, microphones, or any electronic device capable of analyzing, receiving (e.g., receiving user input indicating accept, reject or select a system identified relevant information or answer, user input for conducting insight querying, user input for modifying ruleset, etc.), providing or displaying certain types of data (e.g., rendering of a GUI displaying query results, displaying whether the query results are high confidence or low confidence, highlighting relevant information and/or answer, rendering document, etc.) to a user. The user device may be portable. In some cases, the user device may be located remotely from a human user, and the user can control the user device using wireless and/or wired communications. The user device can be any electronic device with a display.

User device 601-1, 601-2, 601-3 may include one or more processors that are capable of executing non-transitory computer readable media that may provide instructions for one or more operations consistent with the disclosed embodiments. The user device may include one or more memory storage devices comprising non-transitory computer readable media including code, logic, or instructions for performing the one or more operations. For example, when the application is about information extraction or retrieval, the user device may include software applications that allow the user to search or query information in one or more documents (e.g., software application provided by third-party server 630), and/or software applications provided by the system 621 that allow the user device to communicate with and transfer data between server 620, the system 621, and/or the storage unit (e.g., knowledge base or database 611).

The user device 601-1, 601-2, 601-3 may include a communication unit, which may permit the communications with one or more other components in the platform 600. In some instances, the communication unit may include a single communication module, or multiple communication modules. In some instances, the user device may be capable of interacting with one or more components in the platform 600 using a single communication link or multiple different types of communication links.

User devices 601-1, 601-2, 601-3 may include a display. The display may be a screen. The display may or may not be a touchscreen. The display may be a light-emitting diode (LED) screen, OLED screen, liquid crystal display (LCD) screen, plasma screen, or any other type of screen. The display may be configured to show a user interface (UI) or a graphical user interface (GUI) rendered through an application (e.g., via an application programming interface (API) executed on the user device). The GUI may display, for example, a user portal with various features such as document upload, query input field, preview of system identified relevant information, relevant sections, extractive answer, a confidence label (e.g., high confidence, low confidence) associated with the relevant section or the extractive answer, and the like. The user device may also be configured to display webpages and/or websites on the Internet. One or more of the web pages/websites may be hosted by server 620, the third-party system 630 and/or rendered by the system 621.

In some cases, users may utilize the user devices to interact with the system 621 or the third-party system 630 by way of one or more software applications (i.e., client software) running on and/or accessed by the user devices, wherein the user devices and the system 621 or the third-party system 630 may form a client-server relationship. For example, the user devices may run dedicated mobile applications or software applications for accessing the client portal provided by the system 621 or the third-party system 630. The software applications for managing the platform (e.g., admin portal), document processing, and for conducting insight query may be different applications. The client application can be any application where predictions are made. For example, the client application may comprise different interfaces/modes for a user to modify/specify heuristics for determining relevancy, perform insight query and view query result, the associated confidence label (e.g., high confidence or low confidence), select, reject or accept system identified relevant information, sections or answers, to manage the AI engine or handcrafted rules, respectively.

In some cases, the client software (i.e., software applications installed on the user devices 601-1, 601-2, 601-3) may be available either as downloadable software or mobile applications for various types of computer devices. Alternatively, the client software can be implemented in a combination of one or more programming languages and markup languages for execution by various web browsers. For example, the client software can be executed in web browsers that support JavaScript and HTML rendering, such as Chrome, Mozilla Firefox, Internet Explorer, Safari, and any other compatible web browsers. The various embodiments of client software applications may be compiled for various devices, across multiple platforms, and may be optimized for their respective native platforms.

In some cases, the provided platform may generate one or more graphical user interfaces (GUIs). The GUIs may be rendered on a display screen on a user device 601-1, 601-2, 601-3. A GUI is a type of interface that allows users to interact with electronic devices through graphical icons and visual indicators such as secondary notation, as opposed to text-based interfaces, typed command labels or text navigation. The actions in a GUI are usually performed through direct manipulation of the graphical elements. In addition to computers, GUIs can be found in hand-held devices such as MP3 players, portable media players, gaming devices and smaller household, office and industry equipment. The GUIs may be provided in software, a software application, a mobile application, a web browser, or the like. The GUIs may be displayed on a user device (e.g., desktop computers, laptops or notebook computers, mobile devices, smart phones, personal digital assistants (PDAs), and tablets).

User devices may be associated with one or more users. In some embodiments, a user may be associated with a unique user device. Alternatively, a user may be associated with a plurality of user devices. A user may be registered with the platform. In some cases, for a registered user, user profile data may be stored in a database (e.g., database 623) along with a user ID uniquely associated with the user. The user profile data may include, for example, user names, user ID, identity, business field, contact information, historical data, and various others. In some cases, a registered user may be permitted to share or publish exported insight information with other users or store the insight information in a storage space provided by the system.

A server 620 may access and execute the system 621 to perform one or more processes consistent with the disclosed embodiments. In certain configurations, the system may be software stored in memory accessible by a server (e.g., in memory local to the server or remote memory accessible over a communication link, such as the network). Thus, in certain aspects, the system(s) may be implemented as one or more computers, as software stored on a memory device accessible by the server, or a combination thereof.

In some embodiments, one or more systems or components of the present disclosure are implemented as a containerized application (e.g., application container or service containers). The application container provides tooling for applications and batch processing such as web servers with Python or Ruby, JVMs, or Hadoop or HPC tooling. The various functions performed by the system such as the confidence model, document processing, retriever-reader pipelines, generating ruleset for further modifying AI predictions, data labelling, model training, executing a trained model, inspecting and correcting the results of a model prediction, updating and retraining a model using user feedback data and the like may be implemented in software, hardware, firmware, embedded hardware, standalone hardware, application specific-hardware, or any combination of these. The system, and techniques described herein may be realized in digital electronic circuitry, integrated circuitry, specially designed ASICs (application specific integrated circuits), computer hardware, firmware, software, and/or combinations thereof. These systems, devices, and techniques may include implementation in one or more computer programs that are executable and/or interpretable on a programmable system including at least one programmable processor, which may be special or general purpose, graphics processing unit (GPU), coupled to receive data and instructions from, and to transmit data and instructions to, a storage system, at least one input device, and at least one output device. These computer programs (also known as programs, software, software applications, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, and/or device (such as magnetic discs, optical disks, memory, or Programmable Logic Devices (PLDs)) used to provide machine instructions and/or data to a programmable processor.

The third-party system 630 can be any existing platforms or systems that provide document processing, data management and the like. For example, the third-party system may provide software applications to process and analyze document and the insight retrieval functions may be integrated into the applications running on the third-party system 630. In some cases, the third-party system may be in direct communication with the system 621 such that the document processing, information retrieval and the like may be integrated into the third-party application such as via an API.

In some cases, the server 620 may also be configured to store, retrieve, and/or analyze data and information stored in one or more of the storage unit (e.g., knowledge base, databases). The data and information may include converted document dataset, indexes (e.g., sparse index, dense index, etc.), extracted information or insight (e.g., locations and offset of tokens identifying start and end of relevant information or answer), user feedback data, query input data, data about a predictive model (e.g., parameters, model architecture, training dataset, performance metrics, threshold, etc.), and the like. While FIG. 6 illustrates the server as a single server, in some embodiments, multiple devices may implement the functionality associated with a server.

A server may include a web server, an enterprise server, or any other type of computer server, and can be computer programmed to accept requests (e.g., HTTP, or other protocols that can initiate data transmission) from a computing device (e.g., user device) and to serve the computing device with requested data. In addition, a server can be a broadcasting facility, such as free-to-air, cable, satellite, and other broadcasting facility, for distributing data. A server may also be a server in a data network (e.g., a cloud computing network).

A server may include known computing components, such as one or more processors, one or more memory devices storing software instructions executed by the processor(s), and data. A server can have one or more processors and at least one memory for storing program instructions. The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the methods can be implemented in hardware components or combinations of hardware and software such as, for example, ASICs, special purpose computers, or general purpose computers.

Network 610 may be a network that is configured to provide communication between the various components illustrated in FIG. 6. The network may be implemented, in some embodiments, as one or more networks that connect devices and/or components in the network layout for allowing communication between them. For example, user device 601-1, 601-2, 601-3 third-party system 630, server 620, system 621, and storage units 611, 623 may be in operable communication with one another over network 610. Direct communications may be provided between two or more of the above components. The direct communications may occur without requiring any intermediary device or network. Indirect communications may be provided between two or more of the above components. The indirect communications may occur with aid of one or more intermediary devices or networks. For instance, indirect communications may utilize a telecommunications network. Indirect communications may be performed with aid of one or more routers, communication towers, satellites, or any other intermediary device or network. Examples of types of communications may include, but are not limited to: communications via the Internet, Local Area Networks (LANs), Wide Area Networks (WANs), Bluetooth, Near Field Communication (NFC) technologies, networks based on mobile data protocols such as General Packet Radio Services (GPRS), GSM, Enhanced Data GSM Environment (EDGE), 3G, 4G, 5G or Long Term Evolution (LTE) protocols, Infra-Red (IR) communication technologies, and/or Wi-Fi, and may be wireless, wired, or a combination thereof. In some embodiments, the network may be implemented using cell and/or pager networks, satellite, licensed radio, or a combination of licensed and unlicensed radio. The network may be wireless, wired, or a combination thereof.

User device 601-1, 601-2, 601-3, third-party system 630, server 620, or system 621, may be connected or interconnected to one or more storage units (e.g., databases, knowledge bases) 611, 623. The databases may be one or more memory devices configured to store structured data. Additionally, the databases may also, in some embodiments, be implemented as a computer system with a storage device. In one aspect, the databases may be used by components of the network layout to perform one or more operations consistent with the disclosed embodiments. One or more local databases, and cloud databases of the platform may utilize any suitable database techniques. For instance, structured query language (SQL) or “NoSQL” database may be utilized for storing the document data, indexes, data generated by a predictive model such as extracted insight (e.g., relevant section, information, answer, etc.), training datasets (e.g., correctness measures, scores) for the confidence model, the confidence labels, and the like. Some of the databases may be implemented using various standard data-structures, such as an array, hash, (linked) list, struct, structured text file (e.g., XML), table, JavaScript Object Notation (JSON), NOSQL and/or the like. Such data-structures may be stored in memory and/or in (structured) files. In another alternative, an object-oriented database may be used. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. In some embodiments, the database may include a graph database that uses graph structures for semantic queries with nodes, edges and properties to represent and store data. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in variations through standard data processing techniques. Portions of databases, e.g., tables, may be exported and/or imported and thus decentralized and/or integrated.

The storage unit may comprise knowledge bases utilized to store complex structured and unstructured information generated and retrieved by the system. The knowledge base may be an object model with classes, subclasses and instances for storing, for example, user feedback data, extracted information and various other data and information as described elsewhere herein.

In some cases, the platform 600 may construct the database for fast and efficient data retrieval, query and delivery. For example, the system 621 may provide customized algorithms to extract, transform, and load (ETL) the data. In some embodiments, the system 621 may construct the databases using proprietary database architecture or data structures to provide an efficient database model that is adapted to large scale databases, is easily scalable, is efficient in query and data retrieval, or has reduced memory requirements in comparison to using other data structures.

In some embodiments, the one or more storage systems 623, 611, which may be configured for storing or retrieving relevant data as described elsewhere herein. In some cases, the system 621 may source data or otherwise communicate (e.g., via the one or more networks 610) with one or more external systems or data sources 611 (e.g., document storage), and third party system 630. In some instances, the system 621 may retrieve data from the storage systems 611, 623 which are in communication with the one or more external systems (e.g., external document management system, etc.) or third-party systems 630 (e.g., industry or company proprietary systems, etc.).

In some cases, the storage systems can store algorithms or ruleset utilized by one or more methods disclosed herein. In certain embodiments, one or more of the databases may be co-located with the server, may be co-located with one another on the network, or may be located separately from other devices. One of ordinary skills will recognize that the disclosed embodiments are not limited to the configuration and/or arrangement of the database(s). In some cases, data stored in the knowledge base, databases or external databases can be utilized or accessed by a variety of applications through application programming interfaces (APIs). Access to the database may be authorized at per API level, per data level (e.g., type of data), per application level or according to other authorization policies.

Although particular computing devices are illustrated and networks described, it is to be appreciated and understood that other computing devices and networks can be utilized without departing from the spirit and scope of the embodiments described herein. In addition, one or more components of the network layout may be interconnected in a variety of ways, and may in some embodiments be directly connected to, co-located with, or remote from one another, as one of ordinary skill will appreciate.

Various aspects of the present disclosure may be applied to any of the particular applications set forth below or for any other types of applications or systems. Systems or methods of the present disclosure may be employed in a standalone manner, or as part of a package. The system may also allow for an easy and flexible integration of the various personalization features into any existing third-party website or platforms. For instance, the system may provide a plurality of options such as raw application programming interface (API), Plugins, SDK, Google Tag Manager and the like for integrating the AI-based outputs (e.g., extracted information, relevant sections, answer to a question, etc.) to a third-party platform. For example, the system may create various API endpoints for rending frontend elements and code injection. One or more features (e.g., insight query, document processing, etc.) of the system may be integrated to a third-party application (e.g., company's proprietary software, document management system, etc.). For instance, the system may include a family of plugins, extensions, modules and scripts that facilitate development and integration of the document analysis, and services into third-party platforms.

The confidence model and methods can be used in combination with any other functions, systems, platforms, or applications where predictions are made. The predictions may or may not be related to NLP. For example, a confidence label associated with a prediction result indicating whether the result is high confidence or low confidence may be displayed on a GUI. In some cases, the prediction result determined to be low confidence may be hidden from the user. Alternatively, the low-confidence result may also be displayed on the GUI along a the low-confidence indicator.

In some cases, the system integrated with the confidence model may be implemented on a cloud platform system (e.g., including a server or serverless) that is in communication with one or more user systems/devices via a network. The cloud platform system may be configured to provide the aforementioned functionalities to the users via one or more user interface. The user interface may comprise a graphical user interfaces (GUIs), which may include, without limitation, web-based GUIs, client-side GUIs, or any other GUI as described above. For example, a user may upload document and perform insight query via a web-based-GUIs or within a web browser.

A graphical user interface (GUI) is a type of interface that allows users to interact with electronic devices through graphical icons and visual indicators such as secondary notation, as opposed to text-based interfaces, typed command labels or text navigation. The actions in a GUI are usually performed through direct manipulation of the graphical elements. In addition to computers, GUIs can be rendered in hand-held devices such as mobile devices, MP3 players, portable media players, gaming devices and smaller household, office and industry equipment. The GUIs may be provided in a software, a software application, a web browser, etc. The GUIs may be displayed on a user device or user system (e.g., mobile device, personal computers, personal digital assistants, cloud computing system, etc.). The GUIs may be provided through a mobile application or web application.

In some cases, the graphical user interface (GUI) or user interface may be provided on a display. The display may or may not be a touchscreen. The display may be a light-emitting diode (LED) screen, organic light-emitting diode (OLED) screen, liquid crystal display (LCD) screen, plasma screen, or any other type of screen.

In some cases, one or more systems or components of the system (e.g., frontend component, backend component) may be implemented as a containerized application (e.g., application container or service containers). The application container may provide tooling for applications and batch processing, such as web servers with Python or Ruby, JVMs, or even Hadoop or HPC tooling. For instance, the frontend of the system may be implemented as a web application using the framework (e.g., Django Python) hosted on an Elastic Cloud Compute (EC2) instance on Amazon Web Services (AWS). The backend of the system may be implemented as serverless compute service such as hosted on AWS Lambda as a serverless compute service running a web framework for developing RESTful APIs (e.g., FastAPI). This may beneficially allow for a large-scale implementation of the system. In some cases, the backend system (e.g., AWS Lambda) may partition a separate (e.g., 10 GB RAM) compute service for each independent document(s) submission and/or session, allowing for a large number of concurrent submissions.

In some cases, one or more functions or operations consist with the methods described herein can be provided as software application that can be deployed as a cloud service, such as in a web services model. A cloud-computing resource may be a physical or virtual computing resource (e.g., virtual machine). In some embodiments, the cloud-computing resource is a storage resource (e.g., Storage Area Network (SAN), Network File System (NFS), or Amazon S3®), a network resource (e.g., firewall, load-balancer, or proxy server), an internal private resource, an external private resource, a secure public resource, an infrastructure-as-a-service (IaaS) resource, a platform-as-a-service (PaaS) resource, or a software-as-a-service (SaaS) resource. Hence, in some embodiments, a cloud-computing service provided may comprise an IaaS, PaaS, or SaaS provided by private or commercial (e.g., public) cloud service providers.

It should be noted that methods and systems of the present disclosure may utilize any type of machine learning algorithms, architectures or approaches. The machine learning algorithm may comprise one or more of the following: a support vector machine (SVM), a naïve Bayes classification, a linear regression, a quantile regression, a logistic regression, a random forest, a neural network, convolutional neural network (CNN), recurrent neural network (RNN), a gradient-boosted classifier or regressor, or another supervised or unsupervised machine learning algorithm (e.g., generative adversarial network (GAN), Cycle-GAN, etc.).

Aspects of the systems and methods provided herein can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The present disclosure provides methods and systems for generating a confidence label for a prediction produced by a predictive model. The method comprises: (a) generating training datasets for training a confidence model, the training datasets are generated using data collected from a cross validation process for evaluating the predictive model; (b) training the confidence model using the training datasets to learn a relationship between a score assigned by the predictive model to a prediction and a correctness measure of the prediction; and (d) feeding an input to the trained confidence model to output a confidence label. The input comprises a target precision or a target recall for a new prediction produced by the predictive model and a score assigned to the new prediction, and the confidence label indicates whether the new prediction is high confidence or low confidence.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

1. A method for generating a confidence label for a prediction, the method comprising:
generating training datasets for training a confidence model;
training the confidence model using the training datasets to learn a relationship between a score assigned to a prediction and a correctness measure of the prediction; and
feeding an input to the trained confidence model to output a confidence label, wherein the input comprises a target precision or a target recall for a new prediction produced by a predictive model and a score assigned to the new prediction, and wherein the confidence label indicates that the new prediction is high confidence or low confidence.

2. The method of claim 1, wherein the training datasets are generated using data collected from a cross validation process for evaluating the predictive model.

3. The method of claim 2, wherein the training datasets comprise paired datapoints.

4. The method of claim 3, wherein each paired datapoint comprises a score assigned to a given prediction by the predictive model and a corresponding correctness measure.

5. The method of claim 4, wherein the correctness measure is calculated based at least in part on the prediction produced by the predictive model during the cross validation process and a ground truth label.

6. The method of claim 1, wherein the relationship is based on a precision-recall analysis.

7. The method of claim 6, wherein the relationship comprises one or more optimal points identified based at least in part on a precision-recall curve or a precision-recall-gain curve.

8. The method of claim 1, wherein the confidence label is binary.

9. The method of claim 1, wherein the prediction produced by the predictive model comprises insight information extracted from a document in response to a user input.

10. The method of claim 9, wherein the prediction comprises a chunk of texts relevant to the user input.

11. A non-transitory computer-readable storage medium including instructions that, when executed by one or more processors, cause the one or more processors to perform operations comprising:
generating training datasets for training a confidence model;
training the confidence model using the training datasets to learn a relationship between a score assigned to a prediction and a correctness measure of the prediction; and
feeding an input to the trained confidence model to output a confidence label, wherein the input comprises a target precision or a target recall for a new prediction produced by a predictive model and a score assigned to the new prediction, and wherein the confidence label indicates that the new prediction is high confidence or low confidence.

12. The non-transitory computer-readable storage medium of claim 11, wherein the training datasets are generated using data collected from a cross validation process for evaluating the predictive model.

13. The non-transitory computer-readable storage medium of claim 12, wherein the training datasets comprise paired datapoints.

14. The non-transitory computer-readable storage medium of claim 13, wherein each paired datapoint comprises a score assigned to a given prediction by the predictive model and a corresponding correctness measure.

15. The non-transitory computer-readable storage medium of claim 14, wherein the correctness measure is calculated based at least in part on the prediction produced by the predictive model during the cross validation process and a ground truth label.

16. The non-transitory computer-readable storage medium of claim 11, wherein the relationship is based on a precision-recall analysis.

17. The non-transitory computer-readable storage medium of claim 16, wherein the relationship comprises one or more optimal points identified based at least in part on a precision-recall curve or a precision-recall-gain curve.

18. The non-transitory computer-readable storage medium of claim 11, wherein the confidence label is binary.

19. The non-transitory computer-readable storage medium of claim 11, wherein the prediction produced by the predictive model comprises insight information extracted from a document in response to a user input.

20. The non-transitory computer-readable storage medium of claim 19, wherein the prediction comprises a chunk of texts relevant to the user input.
